(19) United States
(12) Patent Application Publication
(10) Pub. No.: US 2004/0133362 A1
(43) Pub. Date: Jul. 8, 2004

(54) Method for significantly increasing computational speed, accuracy and versatility of electromagnetic reconstruction of shapes and composition of complex targets containing lossy materials

(75) Inventors: Eytan Barouch, Brookline, MA (US); Stephen L. Knodle, Newton, MA (US)

Correspondence Address: Eytan Barouch, Suite 1004, 1265 Beacon St., Brookline, MA, 02446, US

(73) Assignee: EMIT Systems Co.

(21) Appl. No.: 10/690,106

(22) Filed: Oct. 21, 2003

Related U.S. Application Data
(60) Provisional application No. 60/420,090, filed on Oct. 21, 2002.
(60) Provisional application No. 60/419,834, filed on Oct. 21, 2002.

(51) Int. Cl. G06F 19/00

(52) U.S. Cl. 702/28

(57) ABSTRACT

A method is provided for rapidly reconstructing the surface, shape and material composition of objects reflecting and scattering electromagnetic radiation of a broad band spectrum, and analyzing the reflected intensity of the scattered radiation from complex 2D and 3D structures, applicable to nano-structures as well as micro-wave technologies. This method is done by simultaneously analyzing all unpolarized as well as incident polarized waves, both for TE and TM polarizations. A numerical grid is used that is larger than the feature sizes, but that accurately yields feature size predictions much smaller than the critical dimensions of the structure. This method enables in-situ and on-line analysis to be carried out on a single processor. The method also improves the ability of detecting the composition of the scattering object, by analyzing the scattered radiation. This method is applicable to the microchip and nano-technology industry, as well as to microwave applications.

### CROSS REFERENCE TO RELATED APPLICATIONS

Benefit is claimed, under 35 U.S.C. 119(e), to the filing date of provisional patents applications serial Nos. 60/420,090 and 60/419,834, entitled “Method for analyzing light simultaneously of all wavelengths scattered off 2D or 3D micro- or nano-electronic structures”, and “Method for significantly reducing the oscillatory nature of scattered polarized radiation to better enable the solution of the inverse problem of determining the properties of the scatterer”, both filed on Oct. 21, 2002 and both are listing Eytan Barouch, Brookline Mass.; as inventor, for any inventions disclosed in the manner provided by 35 U.S.C. 112. These provisional applications are expressly incorporated herein by reference.

### FIELD OF THE INVENTION

The thrust of this invention is a new methodology for very fast and accurate of structure and composition of objects at wide range of sizes, scattering a wide band of electromagnetic radiation. This invention includes analytical, algorithmic and practical numerical implementation by analyzing the reflected light off of micro- and nano-electronics features for advanced metrology applications, thereby enabling the sizes and features of the structures to be determined on location in real time in a manufacturing environment.

### BACKGROUND OF THE INVENTION

This patent application has to do with a method and algorithm that can be used in conjunction with scatterometry apparatus. The following background, quoted from the background of U.S. Pat. No. 5,963,329, serves fairly well here also as a starting point on the optical measurement of micro and nanoelectronic structures:

“In microelectronics, accurate measurement of feature profiles (i.e. line width, line height, space between lines, and sidewall shape) are very important to optimizing device performance and chip yield. Measurements are needed at many steps in manufacturing to assure that critical dimensions, line profiles, and feature depths are under control. Historically, measurements have been accomplished with the following technologies:

Optical imaging using the resolving power of optical microscopes and image processing to measure small features. However, features smaller than the resolving power of the microscope can not be measured, nor can the line profile.

Electron-beam imaging, particularly the scanning electron microscope (SEM), greatly improves resolution over the optical microscope. However, like optical imaging, top-down SEM imaging does not provide profile information. While imaging a cross-sectioned samples does provide profile information, cross sectioning is destructive, costly, and labor intensive. In addition the signal processing used in SEM imaging introduces uncertainties. Furthermore, electron beams can damage the sample, and this is especially the case when sensitive materials such as photoresist are imaged. In addition, electron beam charging can seriously distort measurement signals, causing beam position deviations. To overcome this problem, conductive coatings are commonly used but coatings or their removal can damage the sample or effect measurement accuracy.

Scanning force microscopy (SFM) utilizes a very small mechanical probe to sense minute atomic forces that act very close to the surface of materials, and SFM can provide high-resolution topographical information, including line profiles. Unfortunately, SFM is slow and operator-intensive, and the quantitative science of the probe tip is uncertain and unreliable.

Surface-contact mechanical-probe technologies, such as surface profilometers, have been used to profile large structures but do not offer the resolution or sensitivity required by today's characterization requirements. Furthermore, contact-probes distort surfaces. In addition, mechanical stability requirements prohibit the use of probes small enough to accommodate the sub micrometer sizes commonly measured. To measure the width of a line the location of each edge of its profile must be defined, and an arbitrary, qualitative edge detection model is usually used in each of the above measuring techniques. While this arbitrary measurement point is typically calibrated to a cross-section, manufacturing process changes and normal manufacturing process drift can invalidate the edge model and introduce significant measurement error.

Furthermore, none of the above techniques can characterize planarized, buried sub-micron structures that commonly are found in microelectronic or micro-machining manufacturing processes. Features may be formed that are later covered with a transparent (or semi-transparent) layer of material, which is then planarized. If the feature sizes are below the resolution limits of optical techniques and the flat top surface prevents SEM and AFM imaging, none of the above well-known techniques will work.

Two optical techniques are available for planarized buried structures. Scatterometry has been used for characterizing periodic topographic structures in which a light beam (typically a laser) illuminates an area to be characterized and the angular distribution of elastically scattered light is used to measure line widths on photomask and silicon wafer gratings. However, scatterometry requires a high degree of mechanical stability and accurate measurement of the laser beam impingement angle on the grating, and these mechanical limitations contribute to the uncertainty of scatterometry results.

Confocal laser imaging is another optical technique that permits characterization of planarized buried structures. Focus on the sample is progressively adjusted with a monochromatic, high numerical aperture (NA) optical imaging system, and those focus adjustments provide the line profile. The high NA lens has a very small depth of focus, and therefore, a physical profile can be obtained by moving through a series of focus settings up or down the features, and recording those height variations. However, the technique is limited by the resolution of the laser beam, or the size of the laser spot on the sample. Furthermore, the use of a high NA objective lens, providing a large angle to the incident beam limits the ability to characterize high aspect ratio features that are commonly found in semiconductor manufacturing.”

U.S. Pat. No. 5,963,329 went a long way toward improving the above situation. As quoted in the summary of that patent:

“It is therefore an object of the present invention to provide an optical method of determining a line profile of a sub-micron structure. It is a feature of the present invention that the line profile is determined by comparing measured diffraction radiation intensity from a periodic structure on a substrate with modeled radiation intensity predicted from a theoretical line profile. It is a feature of the present invention that line profile parameters of the model are varied until the predicted intensity converges to the measured intensity. It is a feature of the present invention that a rigorous and detailed two-dimensional analytical solution is obtained for the line profile. It is an advantage of the present invention that the line profile is reliably, reproducibly, rapidly, and nondestructively, obtained. These and other objects, features, and advantages of the invention are accomplished by a method of determining the profile of a line comprising the steps of: (a) providing a substrate having a repeating structure comprising a plurality of lines, said lines having substantially identical profiles; (b) illuminating said repeating structure with radiation wherein said radiation diffracts, said diffracted radiation having an intensity; (c) measuring said intensity; (d) providing a model structure on a data processing machine, said model structure comprising a repeating structure on said substrate, said model structure comprising a model profile; (e) mathematically predicting a predicted diffracted radiation intensity when said model structure is illuminated with said radiation; and (f) comparing said predicted intensity with said measured intensity.”

The present invention has to do with an advanced algorithm that works well with either scatterometry or ellipsometry equipment, but in particular shows its highest advantage when used with analyzing light gathered in the usual method of scatterometry.

Now, there is another class of measurement technology, namely, ellipsometry, that we need to mention here that does involve the measurement of light reflected off of substrates at an angle, and measuring the change in intensity and polarization. By describing some of the operation of this measurement procedure, some of the aims/purposes of the present invention will become clearer. In a conventional ellipsometry set-up, the angle of incidence and the angle of reflection of the beam, to the normal of the substrate, are made as nearly equal to each other as possible. Ellipsometry is well known for being able to deduce the complex index of refraction of the substrate, for each wavelength of light used in the illumination. More specifically, by shining well collimated light, at some angle to the normal, of a substrate material, and by collecting and measuring the intensity of the reflected light at the same angle to the normal, and by determining the change in polarization, then it is well known that one can deduce what the complex index of refraction, \check{n}(ω)=n(ω)+ik(ω) will be, for each wavelength of light for which this measurement is made. If the substrate has a single, uniformly composed film layer on it, and if one knows the substrate's optical properties [e.g., \check{n}(k)], and if the film is transparent, then the real part of the complex index of the film, and the film's thickness, can also be deduced. If one has a stack of films, then one can also determine the effective complex index of refraction of the stack of films, provided other information is supplied.

In general, in ellipsometry, the angle of incidence to the normal of the substrate, and the angle of reflection from the substrate, are made identical. For each state of incident radiation (known wavelength, known polarization state, and known angle of incidence to the sample), two measurements can be made, namely, the intensity of the light scattered into the reflected beam, for each of two polarization states that can always be used to characterize the reflected beam. Thus, there are two measurements that can be made for each incident ray and polarization state onto the sample. In the case of a flat substrate, without structure and without films, then these two measurements can be used to deduce n and k for the substrate. If a film exists on the substrate, then n and k for the substrate, and n and k for the film, and the thickness d, cannot all be deduced, as one only has two pieces of information (change in intensity of light into the reflected beam for each exiting polarization state). However, by measuring the substrate properties first without the film, then supplying the information of n and k of the substrate in the second set of measurements of involving the film on the substrate, then one can reduce the number of unknowns in the composite system. There are still too many unknowns, however, namely, n, k, and d for the film. However, if the film is transparent, so that k=0, or if independently one can measure the absorption properties of the film, then one can use the two sets of data obtained from the ellipsometry measurement to deduce n and d for the film. Similar, but more complicated procedures, can be pursued to obtain information about stacks of uniform films [2].

In general ellipsometry practice, there are two other commonly used means for collecting yet more information about the planar substrate and composite film structure. The same set of measurements just described can be done carried out as a function of wavelength, by simply using a broadband light source and filtering the incident light to make it of a narrow wavelength, or quasi-monochromatic, character. For each incident light situation of distinct wavelength, one can carry out the same measurements just described. Thus, one can measure the change in intensity of each polarization state, for more than one wavelength of incident radiation, to thereby gain information regarding the complex index ε(ω)=n(ω)−ik(ω), where n(ω) and k(ω) are functions of the frequency ω. Furthermore, by carrying out this same measurement scenario for different angles of incidence for the radiation on the substrate plane, then yet another entire multiplicity of measurements can be obtained. Thus, for each angle of incidence of light, and for each wavelength of light used in the illumination, there are two measurements that can be obtained in the beam of reflected light, where the reflected light angle to the normal, in ellipsometry, is made equal to the incident angle of the directed light. Most of these points will have bearing on the invention to be described here. Thus, ellipsometry has to do with measuring the properties of light reflected off at an angle from a substrate, with possible layers of uniform film on the substrate, where the incident and reflected light beams have the same angle to the normal to the substrate. Scatterometry has to do with the detection of scattered radiation off of a substrate, typically with a periodic structure in or on the substrate, where one or more angles of scatter from the normal are examined, and where the intensity and polarization of the light, for each wavelength, are compared with that of the incident radiation.

As for the algorithm that is conventionally used in analyzing light obtained via scatterometry methods, the typical technique is to follow a rather computationally intensive approach involving optimizing the number and sizes of a large number of “slabs”of photoresist to yield a reflectivity versus wavelength curve that most closely match the intensity data. Other researchers have also made investigations in scatterometry along these lines, or via matching precalculated libraries of shapes. The present invention does not have any of these limitations.

### BRIEF SUMMARY OF THE INVENTION

In this invention we address these considerations in by developing a system of processes described in FIG. 1. The first task is to evaluate the system being examined for general properties, type of materials involved and their electromagnetic properties. An important decision is whether said materials contain some inherent non-linear polarization properties. The sizes of the features (nano, micro or much larger) as well as the range of needed wavelengths (or frequencies) to resolve and reconstruct the features is evaluated at this initial step. Next are three simultaneous steps: material characterization as a function of frequency immediately transformed to time domain, a “rendering algorithm’ characterizing the scattering object with its seed composition and shape and spatial computational mesh with its corresponding time steps and stability and precision criteria, so a cost function for exit can be defined. The next step consists of inserting the various materials and scattering objects into the developed very-fast and accurate forward scattering algorithm using hybrid method similar to multi-grid analysis, computing the TE, TM polarization of the reflected waves and then the non-polarized spectrum, to go into the cost function for comparison against the target spectrum. Then the structure and composition are updated by various methods (like least square or conjugate gradient) to provide an updated composition and shape to be put back into the system iteratively. When the cost-tolerance is obtained, the system exits and reports its findings.

### BRIEF DESCRIPTION OF DRAWINGS

FIG. 1 illustrates the invention organizational chart.

FIGS. 2, 3 and 4 illustrate the powerful innovation embedded in the module “Findpoles”. In said figures a comparison between target optical parameters and their computed permittivity function is demonstrated, with excellent agreement.

FIG. 5 illustrates the computed and measured spectra using the module “Fwd”. The result of “Findpoles” is applied to a current realistic stack of four layers.

FIGS. 6, 7, 8 and 9 display a photolithography state of the art system, comparing 300 nm and 400 nm pitches of lines and spaces. (L/S). The industrially measured spectra under manufacturing conditions are employed as targets for the module “Invscat”and the closest agreement is given. The reconstructed feature agrees with the SEM measurements to about 0.4%.

### DESCRIPTION OF THE INVENTION

This patent application involves a new methodology to solve Material-Maxwell's equations for electromagnetic scattered beam of composite lossy substrates and isolated or periodic complex and composite objects containing metals as well as absorbing lossy materials. As such, it allows the microchip industry to detect and evaluate critical dimension, affording determination of the manufacturability of micro and nanoelectronic structures. This method of analysis is equally valid for all wavelengths of interest and can be done simultaneously in real time on a single processor for transverse electric (TE) and for transverse magnetic (TM) polarizations. The Material-Maxwell's equations naturally decompose into two separate systems (TE and TM) that can be solved simultaneously. Earlier work as described in U.S. Pat. Nos. 5,963,329, 6,433,878 addresses both facts that the range of validity is very limited and the versatility of shape reconstruction ability is limited to parallel layers only due to the inefficiency of the RCWP theory. Also, both are limited to one wavelength since per calculation since they use an algorithm valid only in frequency space. Another limiting applicability of the RCWP method is its complete disregard to frequencies in the high and low domain, resulting in severe limitations at the deep UV (ultra-violet) range, where most current action takes place.

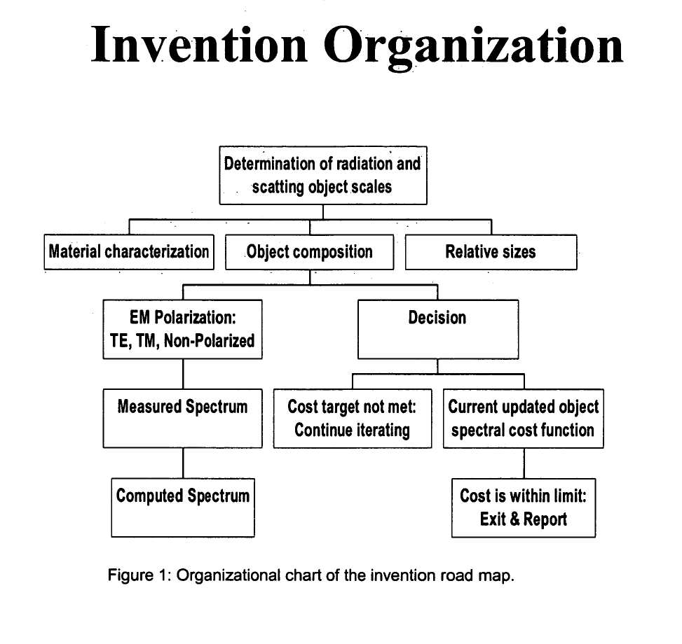

In this invention we address these considerations in by developing a system of processes described in FIG. 1. The first task is to evaluate the system being examined for general properties, type of materials involved and their electromagnetic properties. An important decision is whether said materials contain some inherent non-linear polarization properties. The sizes of the features (nano, micro or much larger) as well as the range of needed wavelengths (or frequencies) to resolve and reconstruct the features are evaluated at this initial step. Next are three simultaneous steps: material characterization as a function of frequency immediately transformed to time domain, a “rendering algorithm’ characterizing the scattering object with its seed composition and shape and spatial computational mesh with its corresponding time steps and stability and precision criteria, so a cost function for exit can be defined. The next step consists of inserting the various materials and scattering objects into the developed very-fast and accurate forward scattering algorithm using hybrid method similar to multi-grid analysis, computing the TE, TM polarization of the reflected waves and then the non-polarized spectrum, to go into the cost function for comparison against the target spectrum. Then the structure and composition are updated by various methods. (like least square or conjugate gradient) to provide an updated composition and shape to be put back into the system iteratively. When the cost-tolerance is obtained, the system exits and reports its findings.

The most critical components of the invention are:

a. The material composition function is obtained by the use of the module “Findpoles”. This module takes a seed table exhibited in Table 2 with the target table exhibited in Table 1. Table 2 expresses the seed as a sum of Debye, Lorenz, Lorenz, Conductivity, plasma and Constant terms. It is then converted to the format given in Table 1, whose columns are the energy in eV, n, k, real permitivity, imaginary permitivity, reflectance and wavelength in nm. A complicated least-square code “Findpoles” is turned on and when tolerance is obtained it exits with the output file displayed in Table 3. There, the inherent frequencies of the material are given in terms of 1/sec, as well as the relaxation parameters. The strength of each term is dimensionless and the conductivity is given in terms of Siemens. As a by product, “Findpoles” provides an efficient and useful extraction method of n&k, that satisfies causality restrictions unlike the claim in U.S. Pat. No. 4,905,170, where causality is violated, rendering it useless for electromagnetic calculations' in time domain.

b. The speed of the forward scattering module “Fwd” is largely obtained due to the ability to express the very large domain of substrate material in terms of a very few grid grid-cells (˜10). This innovation is achieved by a mathematical formulation depicting the large substrate layer as having a “slave” attached lossy layer with equal impudence of the substrate material, thus cutting down the most expensive part of the computational domain substantially, obtaining thousands-fold speed-up. The “slave” layer has poles of the same frequency as the substrate material with different coefficients obtained from equalizing the impedances.

TABLE 1
Input target for “Findpoles”

| energy | n | k | real perm | imag. perm. | reflectivity | wave leng |
|---|---|---|---|---|---|---|
| 8.28859 | 1.708827 | 0.0596079 | 2.91654 | −0.203719 | 0.0689236 | 150 |
| 7.77055 | 1.662666 | 0.0456806 | 2.76237 | −0.151903 | 0.0622138 | 160 |
| 7.31346 | 1.627461 | 0.0361207 | 2.64732 | −0.11757 | 0.0572079 | 170 |
| 6.90716 | 1.600088 | 0.0293165 | 2.55942 | −0.0938179 | 0.0533868 | 180 |
| 6.21644 | 1.561059 | 0.0205597 | 2.43648 | −0.0641897 | 0.0480543 | 200 |
| 5.92042 | 1.546912 | 0.0176593 | 2.39262 | −0.0546349 | 0.0461571 | 210 |
| 5.65131 | 1.535258 | 0.0153793 | 2.35678 | −0.0472224 | 0.0446092 | 220 |
| 5.4056 | 1.525552 | 0.0135557 | 2.32713 | −0.0413597 | 0.0433306 | 230 |
| 4.97315 | 1.510457 | 0.0108553 | 2.28136 | −0.032793 | 0.0413619 | 250 |
| 4.78188 | 1.504526 | 0.0098394 | 2.2635 | −0.0296074 | 0.0405952 | 260 |
| 4.60477 | 1.499413 | 0.0089838 | 2.24816 | −0.0269407 | 0.0399373 | 270 |
| 4.44032 | 1.494974 | 0.008256 | 2.23488 | −0.024685 | 0.0393685 | 280 |
| 4.14429 | 1.487689 | 0.0070913 | 2.21317 | −0.0210994 | 0.0384399 | 300 |
| 4.01061 | 1.484678 | 0.0066207 | 2.20422 | −0.0196592 | 0.0380579 | 310 |
| 3.88528 | 1.482006 | 0.0062079 | 2.1963 | −0.0184002 | 0.0377197 | 320 |
| 3.76754 | 1.479622 | 0.0058435 | 2.18925 | −0.0172924 | 0.0374188 | 330 |
| 3.55225 | 1.475566 | 0.0052317 | 2.17727 | −0.0154395 | 0.0369082 | 350 |
| 3.45358 | 1.473832 | 0.0049732 | 2.17216 | −0.0146592 | 0.0366906 | 360 |
| 3.36024 | 1.472262 | 0.0047403 | 2.16753 | −0.013958 | 0.0364938 | 370 |
| 3.27181 | 1.470835 | 0.0045298 | 2.16334 | −0.0133252 | 0.0363152 | 380 |
| 3.18792 | 1.469534 | 0.0043387 | 2.15951 | −0.0127519 | 0.0361526 | 390 |
| 3.03241 | 1.467254 | 0.0040056 | 2.15282 | −0.0117546 | 0.0358682 | 410 |
| 2.96021 | 1.466252 | 0.0038598 | 2.14988 | −0.0113188 | 0.0357433 | 420 |
| 2.89137 | 1.465329 | 0.0037257 | 2.14718 | −0.0109187 | 0.0356285 | 430 |
| 2.82565 | 1.464476 | 0.003602 | 2.14468 | −0.0105501 | 0.0355224 | 440 |
| 2.7028 | 1.462956 | 0.0033817 | 2.14023 | −0.0098946 | 0.0353336 | 460 |
| 2.64529 | 1.462276 | 0.0032833 | 2.13824 | −0.0096021 | 0.0352493 | 470 |
| 2.59018 | 1.461644 | 0.0031916 | 2.13639 | −0.00933 | 0.0351709 | 480 |
| 2.53732 | 1.461054 | 0.0031061 | 2.13467 | −0.0090764 | 0.0350978 | 490 |
| 2.43782 | 1.459988 | 0.0029513 | 2.13156 | −0.0086179 | 0.0349659 | 510 |
| 2.39094 | 1.459505 | 0.0028811 | 2.13015 | −0.00841 | 0.0349061 | 520 |
| 2.34583 | 1.459052 | 0.0028151 | 2.12882 | −0.0082148 | 0.0348501 | 530 |
| 2.30239 | 1.458626 | 0.002753 | 2.12758 | −0.0080312 | 0.0347975 | 540 |
| 2.22016 | 1.457848 | 0.0026391 | 2.12531 | −0.0076949 | 0.0347014 | 560 |
| 2.18121 | 1.457492 | 0.0025868 | 2.12428 | −0.0075406 | 0.0346574 | 570 |
| 2.1436 | 1.457156 | 0.0025374 | 2.1233 | −0.0073946 | 0.034616 | 580 |
| 2.10727 | 1.456839 | 0.0024904 | 2.12237 | −0.0072563 | 0.0345768 | 590 |
| 2.03818 | 1.456253 | 0.0024036 | 2.12067 | −0.0070005 | 0.0345046 | 610 |
| 2.0053 | 1.455983 | 0.0023633 | 2.11988 | −0.006882 | 0.0344713 | 620 |
| 1.97347 | 1.455727 | 0.002325 | 2.11914 | −0.0067692 | 0.0344398 | 630 |
| 1.94264 | 1.455484 | 0.0022885 | 2.11843 | −0.0066617 | 0.0344098 | 640 |
| 1.88377 | 1.455032 | 0.0022203 | 2.11711 | −0.0064612 | 0.0343542 | 660 |
| 1.85565 | 1.454822 | 0.0021885 | 2.1165 | −0.0063677 | 0.0343283 | 670 |
| 1.82837 | 1.454621 | 0.002158 | 2.11592 | −0.0062782 | 0.0343036 | 680 |
| 1.80187 | 1.45443 | 0.0021288 | 2.11536 | −0.0061925 | 0.0342801 | 690 |
| 1.77613 | 1.454248 | 0.0021009 | 2.11483 | −0.0061104 | 0.0342577 | 700 |
| 1.72679 | 1.453907 | 0.0020483 | 2.11384 | −0.0059561 | 0.0342158 | 720 |
| 1.70313 | 1.453748 | 0.0020236 | 2.11338 | −0.0058835 | 0.0341962 | 730 |
| 1.68012 | 1.453595 | 0.0019998 | 2.11293 | −0.0058137 | 0.0341774 | 740 |
| 1.65772 | 1.453449 | 0.0019769 | 2.11251 | −0.0057466 | 0.0341594 | 750 |
| 1.63591 | 1.453309 | 0.0019549 | 2.1121 | −0.005682 | 0.0341422 | 760 |
| 1.59396 | 1.453045 | 0.0019132 | 2.11134 | −0.0055599 | 0.0341098 | 780 |
| 1.57378 | 1.452921 | 0.0018935 | 2.11098 | −0.0055021 | 0.0340946 | 790 |

TABLE 2
Seed input file into “Findpoles”
find poles 2.1.0b input data
1

| | |
|---|---|
| conduct_term | 1 |
| plasma_term | 1 |
| num_lorentz | 5 |
| num_Xlorentz | 1 |
| num_debye | 0 |

| | | |
|---|---|---|
| 420.00 | 84 | 791 |

| | |
|---|---|
| nlayers | 4 |

| | min | initial | max |
|---|---|---|---|
| eps_inf | 0.1000000015 | 0.8200767636 | 7.0000000000 |
| 1_sigma | 0.0001000000 | 4.8033914566 | 5.0000000000 |
| omega_p1 | 1.0000000000 | 6.5119667053 | 15.0000000000 |
| alpha_p1 | 0.0000000000 | 0.9998378158 | 1.0000000000 |
| S | 0.1000000089 | 6.1372642517 | 9.3000001907 |
| omega | 0.4000000060 | 1.5478570461 | 7.0000000000 |
| gamma | 0.0099999998 | 0.0100028720 | 1.0000000000 |
| S | 0.0399999991 | 2.3346211910 | 4.4000000954 |
| omega | 0.4000000060 | 3.5085842609 | 13.0000000000 |
| gamma | 0.0010000000 | 0.0379080027 | 1.0000000000 |
| S | 0.0399999991 | 0.9923810363 | 4.4000000954 |
| omega | 0.4000000060 | 6.6716189384 | 12.0000000000 |
| gamma | 0.0010000000 | 0.2266924083 | 1.0000000000 |
| S | 0.0399999991 | 1.6832729578 | 4.4000000954 |
| omega | 0.4000000060 | 4.3492865562 | 9.0000000000 |
| gamma | 0.0010000000 | 0.0379193872 | 1.0000000000 |
| S | 0.0149999997 | 4.4830975533 | 8.6999998093 |
| omega | 0.8000000119 | 4.0481534004 | 8.0000000000 |
| gamma | 0.0010000000 | 0.0641734675 | 1.0000000000 |
| XS | 0.1000000089 | 1.8365435600 | 2.2999999523 |
| Xomega | 0.4000000060 | 5.2369093895 | 12.0000000000 |
| Xgamma | 0.0099999998 | 0.1255621761 | 1.0000000000 |
| Xlambda | 0.0099999998 | 0.6012777152 | 1.0000000000 |

TABLE 3
Output material file of “Findpoles” as input file into “Fwd”
Matfile for input into “Fwd”
Output of “Findpoles”

| | |
|---|---|
| 1_eps_inf | 0.71569538 |
| 1_sigma | 8.17777292E+12 |
| 1_numlorentz | 5 |
| 1_numXlorentz | 0 |
| 1_numdebye | 1 |
| deleps_p | 8.52794349E−01 |
| omega_p2 | 6.39123152E+31 |
| delta_p | 6.14708671E+14 |
| deleps_p | 1.57363355E+00 |
| omega_p2 | 2.81803558E+31 |
| delta_p | 1.51713529E+14 |
| deleps_p | 1.68789959E+00 |
| omega_p2 | 9.01482831E+31 |
| delta_p | 2.16371420E+15 |
| deleps_p | 4.39927959E+00 |
| omega_p2 | 4.27885802E+31 |
| delta_p | 3.57961164E+14 |
| deleps_p | 2.52639604E+00 |
| omega_p2 | 3.41288632E+31 |
| delta_p | 3.66798193E+14 |
| delepsD_p | 2.49912262E+01 |
| tauD_p | 4.95714492E−16 |

c. The reconstruction of the scattering object is performed with a hybrid method similar to the LM algorithm with one fundamental variation. The initial Hessian is obtained by localized parameter minimizations, avoiding the extreme inaccuracy involved with numerical derivatives. The initially constructed Hessian provides both seed as well as vector-directions utilizing a Gram-Schmidt procedure.

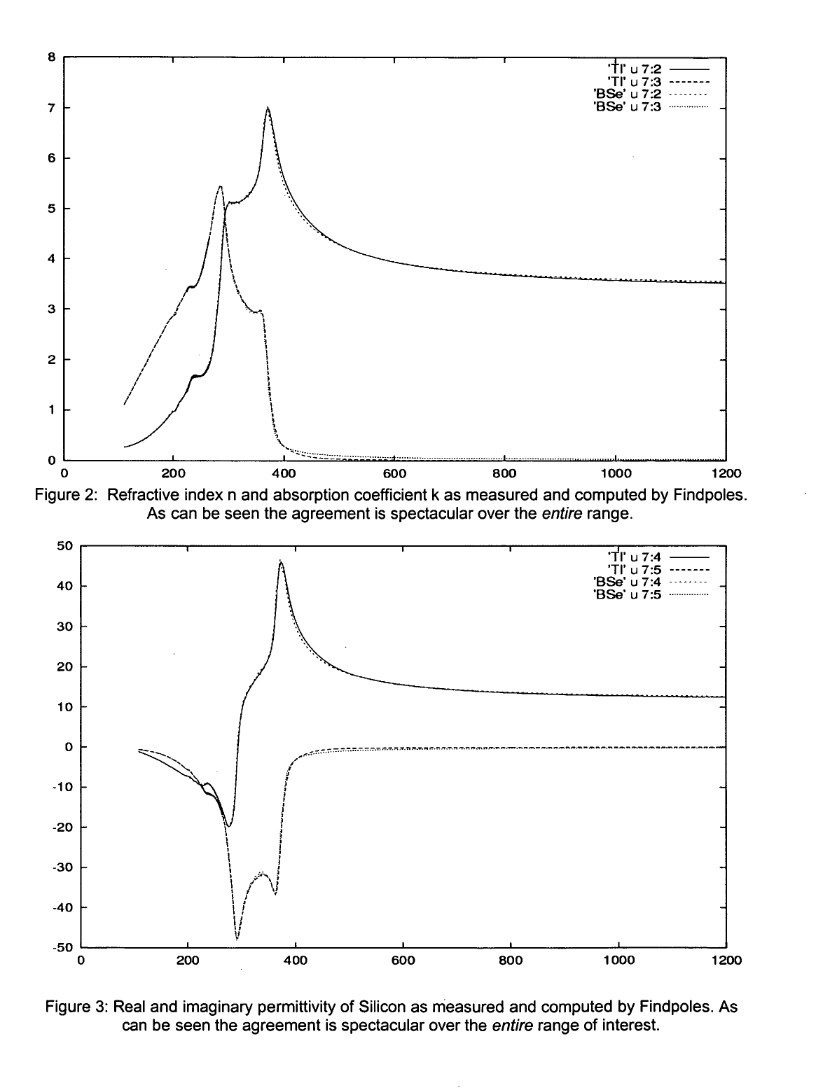

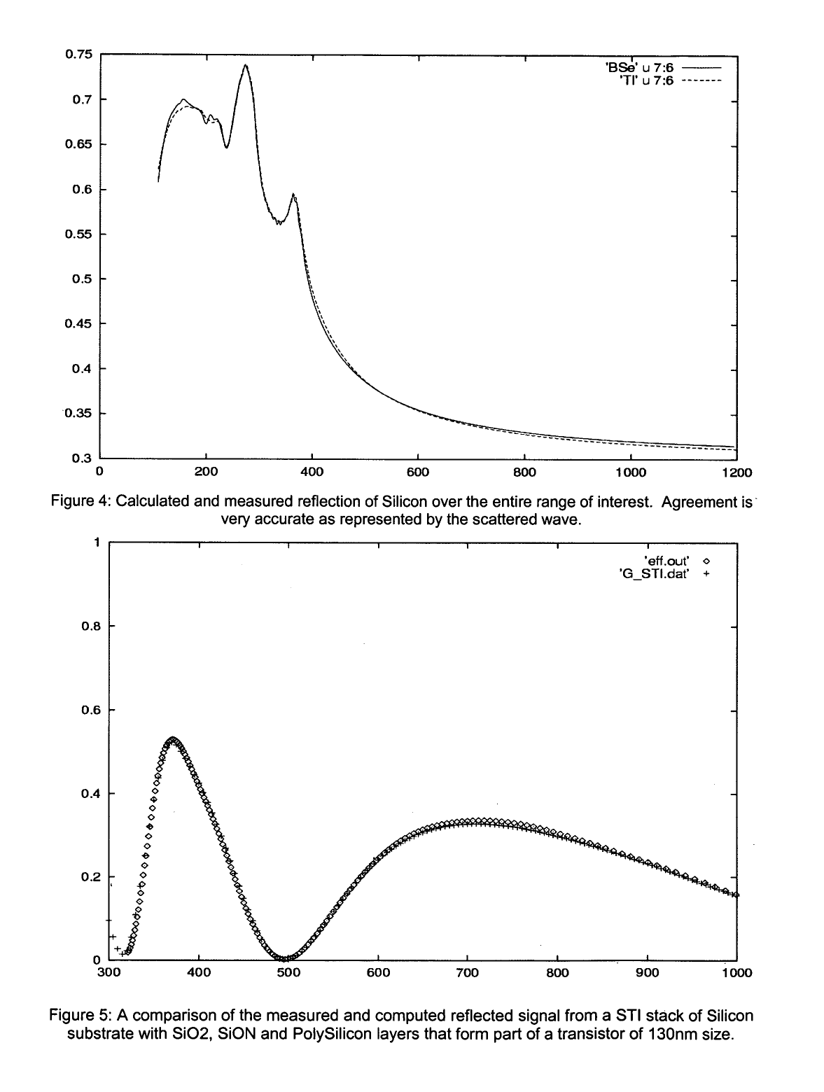

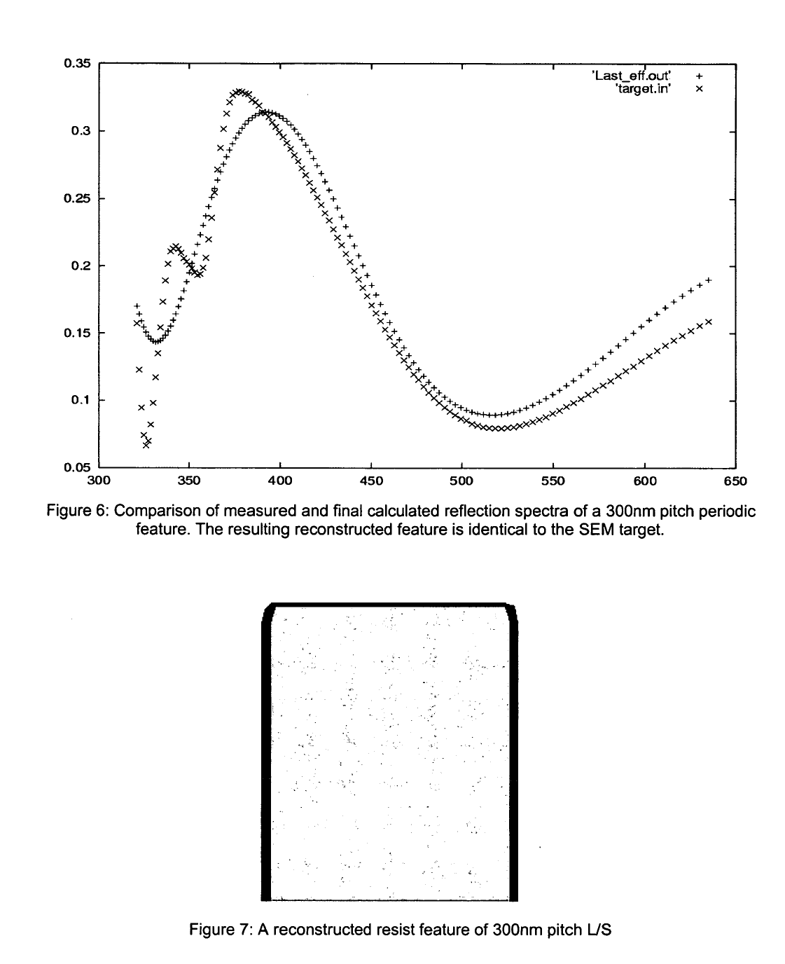

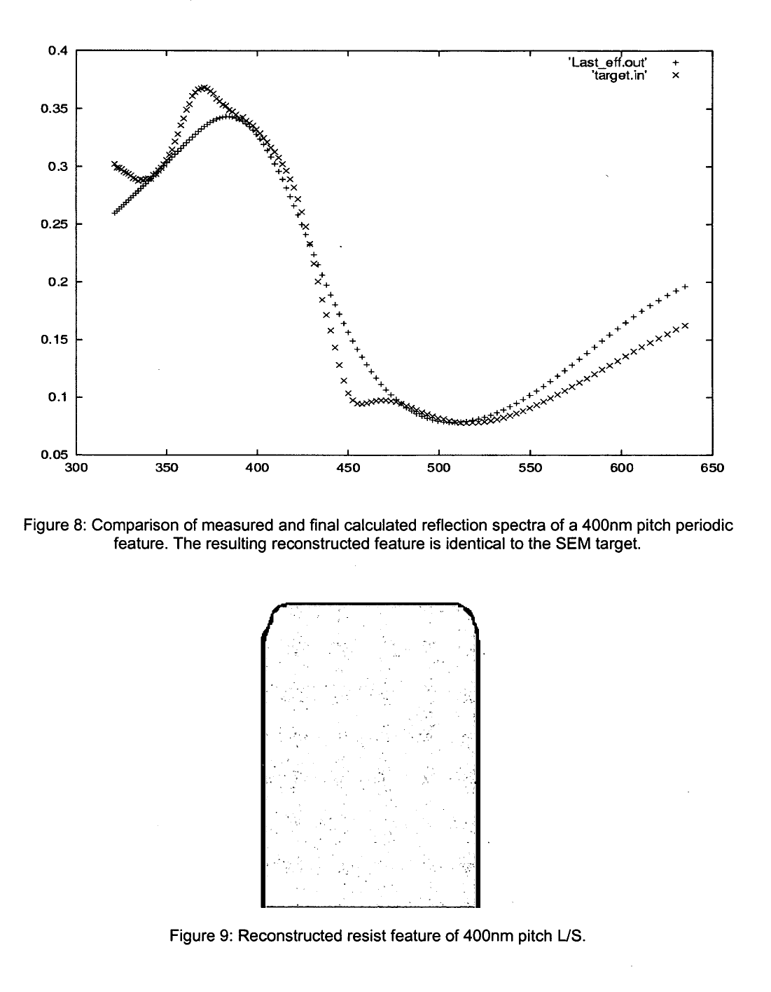

FIGS. 2, 3 and 4 illustrate the powerful innovation embedded in the module “Findpoles”. In said figures a comparison between target optical parameters and their computed permittivity function is demonstrated, with excellent agreement. The result of “Findpoles” is applied to a current realistic stack of four layers and the computed and measured spectra are exhibited in FIG. 5, using the module “Fwd”. In FIGS. 6, 7, 8, 9 a photolithography state of the art system is displayed, comparing 300 nm and 400 nm pitches of lines and spaces (L/S). The industrially measured spectra under manufacturing conditions are employed as targets for the module “Invscat” and the closest agreement is given. The reconstructed feature agrees with the SEM measurements to about 0.4%.

The method described in this invention is accomplished by providing a detailed analysis of the dielectric function of each material in the structure of interest. The functional form of the dielectric function can be expressed in one of two ways. First, it can be given as a sum of a constant and an interactive plasma term (non-magnetized) and several poles of Debye, Lorenz double poles and Linear-Lorenz double poles. Second, the dielectric function may be expressed in terms of the density of states in the corresponding quantum mechanical band, as expressed in an integral equation of Cauchy type, i.e., with a singular kernel, that satisfies the fundamental Kramers-Kronig relationship and is solved by a combination of analytic and numerical techniques. An approximate analytic solution of the integral equation corresponds to a high level of accuracy to the first method just mentioned. The permitivity so described is a representation of the dielectric function in frequency space, and utilized as such forces solution of the Material-Maxwell equations for each wavelength separately, resulting in a very slow execution time as well as severe inaccurate and unreliable results. Consequently, despite the patent of ref. 1, IBM has initially rejected this technology. Furthermore, the dielectric function in frequency space must satisfy several strict restrictions in order for it to represent the real physics it attempting to describe. These restrictions include the Kramers-Kronig relations, causality, positivity of the index of refraction n and the absorption coefficient k, as well as the property that the complex conjugate of the permittivity function as a function of frequency ω is a function of −ω. The real part of the permittivity function is allowed to be positive and negative continuously, presenting another usually ignored difficulty when the real part vanishes. When that happens all classical electromagnetic descriptions become invalid in frequency space and disregarding it for the frequency in which it takes place yields absurd results. A typical material in which this takes place is Silicon, which is a critical material for the microchip industry. The physics behind this occurrence is a change in response of the material from semi-conductor to a temporary plasma containing material. This invention deals in part with overcoming this complication. The time domain dielectric function is the Fourier transform of the permittivity function in frequency space, and as such it is not subjected to the, separation of the real and imaginary parts. However, there is a high price to pay. The Material-Maxwell equations are no longer partial differential equations since they become integral-partial-differential. (IPD) system, which is much harder to handle. An integral part of this invention is the incorporation of the properly characterized material functions into the IPD system allowing a very rapid evaluation of the forward scattering for all wavelengths contained in the source, simultaneously.

For the microchip industry, the Material-Maxwell solver of this invention uses a few nanometer grids. However, the feature that designates the target needs to be characterized up to a fraction of a nanometer. Thus, a rendering algorithm has been developed that divides each grid cell into an arbitrary localized refined mesh where the various weights on the original grid cells are modified according to the materials included in that cell. For example, if each boundary cell is divided into a 10×10 grid, the CD accuracy thus obtained is 0.5 nm. This technique, recently developed and unpublished, is employed to compute the inverse problem of determining the scattering object shape and material composition from the knowledge of the incoming and the scattered beams. It also allows alignment determination of alignment markers and shapes. The speed and accuracy of these algorithms would enable in-situ and on-line metrology for realistic systems.

This invention is equally applicable to 2D&3D micro and nanoelectronic structures. By the development of this method, inspection of OPC (optical proximity corrections) can be obtained in a manufacturing environment, while taking into account alignment and twist location structures.

What is claimed is:

1 A method of solving Material-Maxwell's equations for the analysis of light scattered off 2D or 3D micro or nanoelectronic structures, such that all wavelengths of the incident light can be analyzed and computed simultaneously in real time on a single processor for transverse electric (TE) and for transverse magnetic (TM) polarizations.

2 A method as recited in claim 1, wherein said method is sufficiently general that it can be used on either single or multiple processors.

3 A method as recited in claim 1, wherein said method is applicable to microwave technology of range of a few cm wavelengths.

4 A method as recited in claim 1, wherein said method is able to process complicated lossy material structures, utilizing a unique method of analyzing very large domains in terms of a transformation of small finite domains.

5 A method as recited in claim 1, wherein said method is applied to microchip fabrication encompassing a range of 50 nm-1500 nm uniformly.

6 A method as recited in claim 1, wherein said method is comprising of a “rendering algorithm” that enables the use of a larger numerical grid than the smallest feature sizes, but that enables the scattering target to be characterized up to a fraction of this size.

7 A method as recited in claim 1, wherein said method is employed in the computation of reflected spectra for TE&TM polarization, reporting their ratio as a function of frequency, thus eliminating any spurious oscillations associated with the source.

8 A method of constructing an electrical susceptibility function in time-domain space utilizing measurable optical constants whose components of said function are Lorenz poles, Xlorenz-linear poles, Debye poles, conductivity term, a non-magnetized plasma term and a limiting constant for infinite wavelength.

9 A method as recited in claim 8, wherein said method is satisfying strict causality properties in time domain space.

10 A method as recited in claim 8, wherein said method guarantees that the refractive index and the absorption coefficients (n&k) are positive for all wavelengths.

11 A method as recited in claim 8, wherein said method allows extraction of said n&k recited in claim 10 satisfying strict causality relations, term by term.

12 A method as recited in claim 8, wherein said method provides the structured boundary layer representing large or semi-infinite domain, with poles determined from recited susceptibility function of claim 8, with variation of the coefficients in the numerators, obtained by imposing a non-reflection condition. The conductivity term becomes a mixture of conductivity and collisionless plasma and the plasma term becomes a combination of cited conductivity and Debye terms.

13 A method of scattering object's complex shape and composition.

14 A method as recited in claim 13, wherein said method constructs a seed Hessian without employing numerical derivative, using local parameter minimization as a guide.

15 A method as recited in claim 13, wherein said method makes the reconstruction problem less ill posed by reducing the oscillatory nature of the scattered radiation, by eliminating the need to normalize the radiation source, and analyzing the ratio and relative phase of the TM and TE polarization for each wavelength of interest as the backbone of the cost function.

16 A method as recited in claim 13, wherein said method is equally valid for 2D and 3D structures.
